(19) United States
(12) Patent Application Publication
(10) Pub. No.: US 2026/0072577 A1
(43) Pub. Date: Mar. 12, 2026

(54) INFORMATION INTERACTION

(71) Applicants: Beijing Zitiao Network Technology Co., Ltd., Beijing (CN); Lemon Inc., Grand Cayman (KY)

(72) Inventors: Shiqi Wan, Beijing (CN); Tao Zhu, Singapore (SG)

(21) Appl. No.: 19/320,032

(22) Filed: Sep. 5, 2025

(30) Foreign Application Priority Data
Sep. 6, 2024 (WO) PCT/CN2024/117623

(51) Int. Cl. G06F 3/0484; G06F 40/166

(52) U.S. Cl. CPC G06F 3/0484; G06F 40/166

(57) ABSTRACT

The embodiment of the disclosure relates to an information interaction method, an apparatus, a device and a storage medium. The method provided by the disclosure includes: presenting an interaction portal associated with a first interaction resource sent by a target user, the first interaction resource being generated based on a first prompt; presenting an interaction interface in response to receiving a selection of the interaction portal; determining, via the interaction interface, a second prompt for generating an interaction resource; presenting, in the interaction interface, a second interaction resource generated at least based on the second prompt; and sending the generated second interaction resource to the target user. In this way, the embodiments of the disclosure can improve the efficiency of information interaction.

### CROSS-REFERENCE

This application claims priority to PCT Application No. PCT/CN2024/117623 filed on Sep. 6, 2024, and entitled “METHOD AND APPARATUS FOR INFORMATION INTERACTION, DEVICE, AND STORAGE MEDIUM”, which is incorporated herein by reference in its entirety.

### FIELD

Example embodiments of the present disclosure generally relate to the field of computers, and in particular, to information interaction.

### BACKGROUND

In recent years, with the development of computer technologies, more and more users propagate information on a network platform. However, a traditional network platform can only bear a carrier of information propagation, and cannot generate and process the information content for a user, and cannot meet information interaction requirements of the user.

### SUMMARY

In a first aspect of the present disclosure, a method for information interaction is provided. The method includes: presenting an interaction portal associated with a first interaction resource sent by a target user, the first interaction resource being generated based on a first prompt; presenting an interaction interface in response to receiving a selection of the interaction portal; determining, via the interaction interface, a second prompt for generating an interaction resource; presenting, in the interaction interface, a second interaction resource generated at least based on the second prompt; and sending the generated second interaction resource to the target user.

In a second aspect of the present disclosure, an apparatus for information interaction is provided. The apparatus includes a first presenting module, configured to present an interaction portal associated with a first interaction resource sent by a target user, the first interaction resource being generated based on a first prompt; an interaction module, configured to present an interaction interface in response to receiving a selection of the interaction portal; a determining module, configured to determine, via the interaction interface, a second prompt for generating an interaction resource; a second presenting module, configured to present, in the interaction interface, a second interaction resource generated at least based on the second prompt; and a sending module, configured to send the generated second interaction resource to the target user.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium stores a computer program. The computer program, when executed by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which some embodiments of the present disclosure can be implemented;

FIGS. 2A-2F illustrate example interfaces according to some embodiments of the present disclosure;

FIGS. 3A-3C illustrate example interfaces according to further embodiments of the present disclosure;

FIG. 4 shows a flowchart of an example process of information interaction according to some embodiments of the present disclosure;

FIG. 5 illustrates a schematic structural block diagram of an example apparatus for information interaction according to some embodiments of the present disclosure; and

FIG. 6 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout the present disclosure and any type of embodiment may be included in any section/subsection. Furthermore, the embodiments described in any section/subsection may be combined in any manner with any other embodiment described in the same section/subsection and/or different sections/subsections.

In the description of the embodiments of the present disclosure, the terms “including”, and the like should be understood to be “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, manipulated, forwarded, used, etc., all of which are performed on the premise that the user knows and confirms. Accordingly, when implementing the embodiments of the present disclosure, the types of data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, if the processing of personal information is involved, the processing may be performed on the premise of having a legality basis (for example, obtaining consent of a personal information subject, or necessary for performing a fulfillment contract), and the processing may be performed only within a specified or agreed range. The user rejects personal information other than necessary information required by the basic function, which does not affect the use of the basic function As briefly mentioned above, in recent years, with the development of computer technologies, more and more users propagate information on a network platform. However, a traditional network platform can only bear a carrier of information propagation, and cannot generate and process the information content for a user, and cannot meet information interaction requirements of the user.

The embodiment of the present disclosure provides a scheme for information interaction. According to the scheme, an interaction portal associated with a first interaction resource sent by a target user may be presented, and the first interaction resource is generated based on a first prompt. An interaction interface may be presented in response to receiving a selection of the interaction portal. A second prompt for generating an interaction resource may be presented via the interaction interface. A second interaction resource generated at least based on the second prompt may be presented in the interaction interface. The generated second interaction resource may be sent to the target user.

In this way, the embodiments of the present disclosure may provide the current user with an interaction portal associated with the interaction resource based on the received interaction resource from other users. Further, the current user may determine, based on the interaction portal, a prompt used to generate the interaction resource. In addition, the embodiments of the present disclosure may present, for a user, an interaction resource generated based on the determined prompt, and send the interaction resource to another user. In this way, the embodiments of the present disclosure can generate, for the user, the interaction resource that may meet the user's needs based on the received interaction resource, thereby reducing the difficulty of generating the interaction resource by the user and improving the efficiency of information interaction performed by the user.

Various example implementations of this scheme are described in detail below in conjunction with the accompanying drawings.

### Example Environment

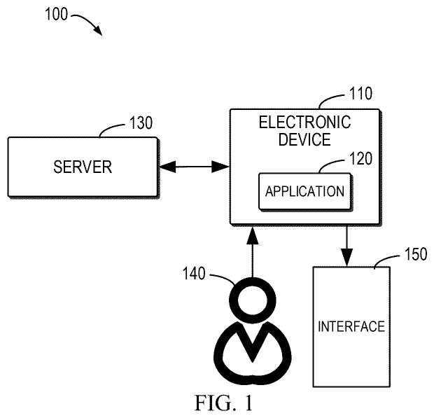

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. Application 120 may be any suitable type of application for interface interaction, examples of which may include, but are not limited to, media editing applications or other suitable applications. The user 140 may interact with the application 120 via the electronic device 110 and/or its attachment device.

In the environment 100 of FIG. 1, if the application 120 is active, the electronic device 110 may present, via the application 120, an interface 150 for supporting interface interaction.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support virtual scenes in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Interaction

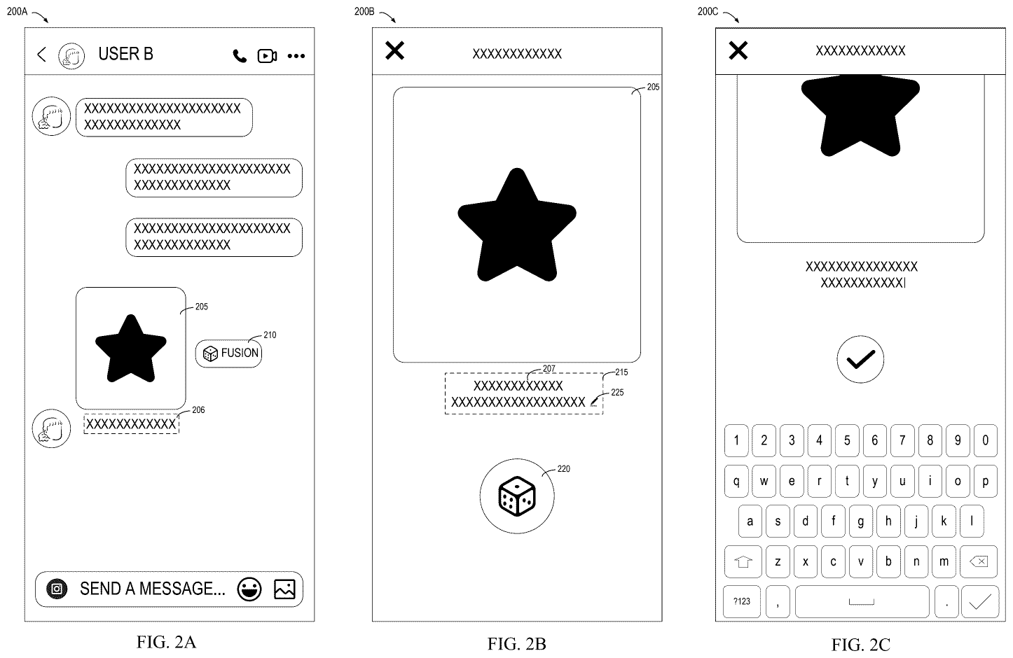

FIGS. 2A-2F illustrate example interfaces 200A-200F according to some embodiments of the present disclosure. The interface 200A to the interface 200F may be provided, for example, by the electronic device 110 shown in FIG. 1.

In some embodiments, the electronic device 110 may present an interaction portal associated with a first interaction resource sent by a target user.

In some embodiments, the electronic device 110 may present the first interaction resource sent by the target user on the target interface.

In some embodiments, the target interface may include a comment interface associated with the target user. The first interaction resource may be presented as at least part of the comment content. As an example, the comment interface may include a comment interface associated with the media content. The comment content may include comment content associated with the media content.

In some embodiments, as shown in FIG. 2A, the electronic device 110 may present the first interaction resource 205 sent by the target user in the target interface 200A. In some embodiments, the target interface 200A may include a session interface with the target user. The first interaction resource 205 is presented in the session interface and is at least part of the session message. As an example, the first interaction resource 205 may be a message sent by the target user to the current user.

In some embodiments, the interaction resource (for example, the first interaction resource and the other interaction resource mentioned later) may include a plurality of types, for example, an expression, a text, an image, an audio, a video, or the like.

In some embodiments, with continued reference to FIG. 2A, the electronic device 110 may present, in the target interface 200A, the first prompt 206 for generating the first interaction resource 205. The first prompt 206 may be used to describe the first interaction resource 205.

As an example, the first interaction resource may be generated by a client associated with the target user by using a predetermined model based on the first prompt and/or other prompt items determined by the target user. As an example, the predetermined model may be implemented as a machine learning model having an ability to generate an interaction resource based on the prompt content, and the present disclosure is not intended to limit the specific content and the training process of the predetermined model. Further, the client associated with the target user may send the first interaction resource to the current user in response to the sending request of the target user. Therefore, the electronic device 110 associated with the current user may present, in the target interface, the first interaction resource 205 and the first prompt 206 from the target user.

In some embodiments, with continued reference to FIG. 2A, the electronic device 110 may present, in the target interface 200A, the interaction portal 210 associated with the first interaction resource 205. As an example, the electronic device 110 may present an image identifier and a text identifier of the interaction portal 210. Further, the electronic device 110 may present the interaction interface in response to a trigger (for example, a click operation) on the interaction portal 210.

In some embodiments, as shown in FIG. 2B, the electronic device 110 may present an interaction interface 200B. The electronic device 110 may present the first interaction resource 205 in the interaction interface 200B. Further, the electronic device 110 may provide a prompt control 215 in the interaction interface 200B. The electronic device 110 may present the first prompt 206 (not shown in FIG. 2B) in the prompt control 215 of the interaction interface 200B in response to a trigger on the interaction portal 210.

In some embodiments, with continued reference to FIG. 2B, the electronic device 110 may present the first editing control 220 in the interaction interface 200B. Further, the electronic device 110 may provide the second prompt 207 generated based on the first prompt 206 in the prompt control 215 in response to the trigger on the first editing control 220.

In some embodiments, the electronic device 110 may indicated the first model to generate the second prompt by replacing the partial content of the first prompt in response to the trigger on the first editing control. As an example, the first prompt 206 may include, for example, “AAA is walking”. The second prompt 207 generated by the first model may include, for example, “the AAA is drinking water”. As an example, the first model may be implemented as a machine learning model with text processing capability. The present disclosure is not intended to limit the specific content and the training process of the first model. In this way, in the embodiments of the present disclosure, the second prompt 207 can be quickly generated for the user based on the received first interaction resource 205, so as to provide reference for the user or help the user generate the second interaction resource based on the second prompt 207, thereby improving the efficiency of the user to generate the second interaction resource.

In some embodiments, with continued reference to FIG. 2B, the electronic device 110 may present a second editing control 225 in the interaction interface 200B. Further, the electronic device 110 may obtain the second prompt 207 determined through editing the first prompt 206 in response to the trigger on the second editing control 225.

In some embodiments, as shown in FIG. 2C, the electronic device 110 may present the keyboard component in the interaction interface 200C in response to a trigger on the second editing control 225. The electronic device 110 may receive the content of the natural language input by the user through the keyboard component, to edit the first prompt 206. As such, embodiments of the present disclosure provide a way for the user to manually edit the second prompt 207. In this way, the embodiments of the present disclosure can provide a free editing function for the user, and can meet the user's requirement for creating the second interaction resource by customizing the second prompt 207.

In some embodiments, the electronic device 110 may present a second interaction resource generated based on at least the second prompt 207. In some embodiments, the electronic device 110 provides the second prompt 207 and the reference information to the second model to obtain the second interaction resource generated by the second model. As an example, the second model may be implemented as a machine learning model having an ability to generate text content or image content based on the prompt content. The present disclosure is not intended to limit the specific content and the training process of the second model.

In some embodiments, the reference information may indicate description information associated with the first interaction resource. As an example, the description information associated with the first interaction resource may include a description of text content and/or image content corresponding to the first interaction resource. In this way, by considering the description information associated with the first interaction resource, the association between the second interaction resource and the first interaction resource can be improved.

As an example, the description information of the first interaction resource may include, for example, a human sticker(for example, a character A is shaking a head) and a painting style (for example, an animation style or an ink and wash painting style). As an example, generating the second interaction resource based on the reference information may include, for example, “the character A is crying” (for example, the character is the same as the character in the first interaction resource, the sticker style is different), and the painting style of the second interaction resource may be the same as the first interaction resource. As an example, here only an exemplary description of the description information, and the description information of the first interaction resource may further include a story line, a theme and tone, an environment condition, and the like. The present disclosure is not intended to limit the description information associated with the first interaction resource.

In some embodiments, the reference information may indicate avatar data of a virtual object associated with the current user. As an example, the virtual object of the current user may be created based on a configuration operation of the current user. In some scenarios, such a virtual object may also be referred to as a digital avatar or a virtual avatar, for example. The image data acquisition of the virtual object may include: the electronic device 110 obtaining at least one image based on a configuration operation of the user. The image data of the virtual object is determined based on the obtained at least one image. As an example, the configuring operation may include selecting an image from an album or taking an image with a camera assembly. As an example, the at least one image may be an image in an album or an image captured by a camera assembly. As an example, the visual representation of the virtual object may be generated based on the avatar data and the descriptive text of the user input. Therefore, by considering the image data of the virtual object associated with the current user, the demand of generating the second interaction resource by the current user can be met, and the relevance and interestingness of the second interaction resource and the current user are improved.

As an example, the second prompt 207 may include, for example, “boating in a lake”, and based on the image data of the virtual object associated with the current user in the reference information, the generated second interaction resource may be presented as “the virtual object associated with the current user being boating in the lake”. In some examples, the avatar in the second interaction resource is determined based on a virtual object associated with the current user.

In some embodiments, as shown in FIG. 2D, the electronic device 110 may present, in the interaction interface 200D, a animation process of generating the second interaction resource based on the second prompt 207. As an example, the electronic device 110 may present the progress indication element 230 in an animation, for example. The progress indication element 230 may indicate the progress of the generation of the second interaction resource. According to the embodiment of the present disclosure, the animation and the progress indication element are presented, so that the making progress of the second interaction resource can be clearly displayed for the current user, so that the user can intuitively feel the making process and the estimated completion time of the second interaction resource.

In some embodiments, as shown in FIG. 2E, the electronic device 110 may present, in the interaction interface 200E, the second interaction resource 235 generated based on at least the second prompt 207.

In some embodiments, with continued reference to FIG. 2E, the electronic device 110 may present the first editing control 220 and/or the second editing control 225 in the interaction interface 200E. Further, the electronic device 110 may update the second prompt 207 in response to a trigger of the first editing control 220 and/or the second editing control 225 by the current user to indicate the second control to regenerate the new second interaction resource 235 based on the updated second prompt 207. Therefore, according to the embodiment of the present disclosure, the second interaction resource can be updated for the user based on the operation of the user until the demand of the user is met.

In some embodiments, with continued reference to FIG. 2E, the electronic device 110 may present the sending control 240 associated with the second interaction resource 235 in the interaction interface 200E. Further, the electronic device 110 may send the generated second interaction resource 235 to the target user in response to a trigger on the sending control 240.

In some embodiments, as shown in FIG. 2F, the electronic device 110 may present, in the target interface 200F, the second interaction resource 235 sent from the current user to the target user. In some embodiments, the electronic device 110 may further present a second prompt 207 associated with the second interaction resource 235 in the target interface 200F.

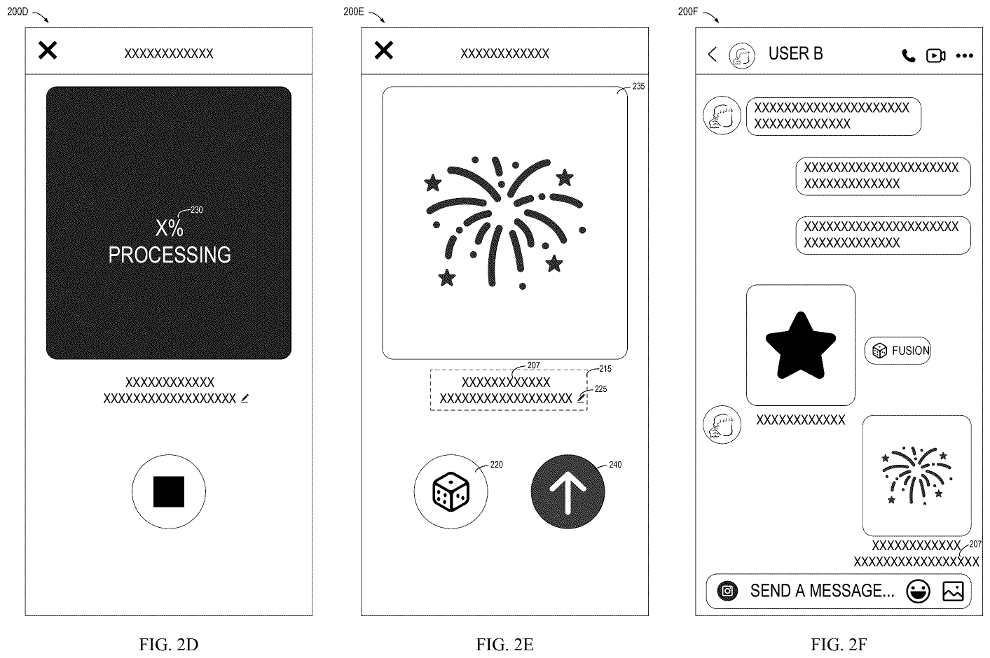

FIGS. 3A-3C illustrate example interfaces 300A-300C according to some embodiments of the present disclosure. The interface 300A to the interface 300C may be provided, for example, by the electronic device 110 shown in FIG. 1.

In some embodiments, as shown in FIG. 3A, the electronic device 110 may present the target interface 300A. The electronic device 110 may present the first interaction resource 305 from the target user in the target interface 300A.

In some embodiments, with continued reference to FIG. 3A, the electronic device 110 may provide an input control 310 in the target interface 300A. The electronic device 110 may obtain the target content input by the current user via the input control 310.

In some embodiments, as shown in FIG. 3B, the electronic device 110 may present the keyboard component 315 in response to a trigger on the input control 310. The electronic device 110 may determine the target content 320 input by the current user in response to a triggering on the keyboard component by the current user.

In some embodiments, with continued reference to FIG. 3B, the electronic device 110 may present a third interaction resource 325 associated with the target content 320 in the target interface 300B. As an example, the third interaction resource 325 may include a plurality of interaction resources. In some embodiments, the plurality of interaction resources are arranged based on a predetermined rule. As an example, the predetermined rule may include that the interaction resources generated based on the prompts in the plurality of interaction resources are arranged in the first place, and the other interaction resources are arranged in the second place. In addition, the predetermined rule may be further determined based on time information of the interaction resource.

In some embodiments, the electronic device 110 may present, in the target interface 300B, the third interaction resource 325 associated with the target content 320 in response to the target content 320 satisfying the predetermined condition. As an example, the predetermined condition may include that a text length of the target content 320 meets a predetermined length, a language type of the target content 320 meets a predetermined language type, and the like.

In some embodiments, after receiving the target content 320 input by the current user, the electronic device 110 may present, in the target interface 300B, the third interaction resource 325 associated with the target content 320 in response to that a time interval without receiving an operation of the current user reaches a predetermined time threshold. As an example, after receiving the target content 320 input by the current user, the electronic device 110 may present, in the target interface 300B, the third interaction resource 325 associated with the target content 320 in response to that no operation of the current user is received within 3 seconds.

In some embodiments, the third interaction resource 325 may be generated based on the target content. As an example, the electronic device 110 may indicate the third model to generate the third interaction resource based on at least the target content. As an example, the third model may be implemented as a machine learning model having an ability to generate text content or image content based on the prompt content. The present disclosure is not intended to limit the specific content and the training process of the third model.

In some embodiments, the third interaction resource may be an interaction resource matching the target content in the predetermined resource set. As an example, the predetermined resource set may include a plurality of predetermined interaction resources. The plurality of predetermined interaction resources may include the second interaction resource 235 generated based on the second prompt 207 and other interaction resources generated based on the other prompts. In addition, the plurality of predetermined interaction resources may further include an interaction resource (for example, a sticker) that is not generated based on the prompt.

In some embodiments, the electronic device 110 may determine the third interaction resource 325 from the predetermined resource set based on the prompt corresponding to the predetermined resource set. The third prompt corresponding to the third interaction resource 325 matches the target content. As an example, a plurality of predetermined interaction resources in the predetermined resource set may correspond to a plurality of prompts. The electronic device 110 may invoke the text matching model to determine, from the plurality of prompts, a target prompt whose matching degree with the target content is higher than a predetermined threshold, so as to determine that the predetermined interaction resource corresponding to the target prompt is the third interaction resource 325. As an example, the text matching model may be implemented as a machine learning model having text similarity judgment ability. The present disclosure is not intended to limit the specific content and training process of the text matching model. The present disclosure is not intended to limit the specific value of the predetermined threshold.

In some embodiments, with continued reference to FIG. 3B, the electronic device 110 may input the third interaction resource 325 on the page corresponding to the input control 310 in response to the selection of the third interaction resource 325. As an example, the electronic device 110 may input the third interaction resource 325-1 in the target interface 200B in response to selection of the third interaction resource 325-1.

In some embodiments, as shown in FIG. 3C, the electronic device 110 may present the third interaction resource 325-1 in the target interface 300C.

In some embodiments, with continued reference to FIG. 3C, the electronic device 110 may present the prompt element 330 associated with the third interaction resource 325-1 in the target interface 300C. The prompt element 330 may be used to indicate that the third interaction resource 325-1 is generated based on a corresponding prompt. As an example, the third interaction resource 325-1 may be an interaction resource previously generated by the current user based on the prompt and stored in the predetermined resource set.

Based on the above process, in the embodiments of the present disclosure, after receiving the interaction resource from the other user, the associated interaction resource is recommended for the current user based on the current user input content, or the user-based operation helps to generate the interaction resource based on the prompt for the user. Moreover, the embodiments of the present disclosure can send the interaction resource to other users and store them in a predetermined resource set for subsequent use of the current user. In this way, the embodiments of the present disclosure can help a user quickly find or create an interaction resource to meet the information interaction requirement of the user and other users, and improve the information interaction efficiency between users.

### Example Processes

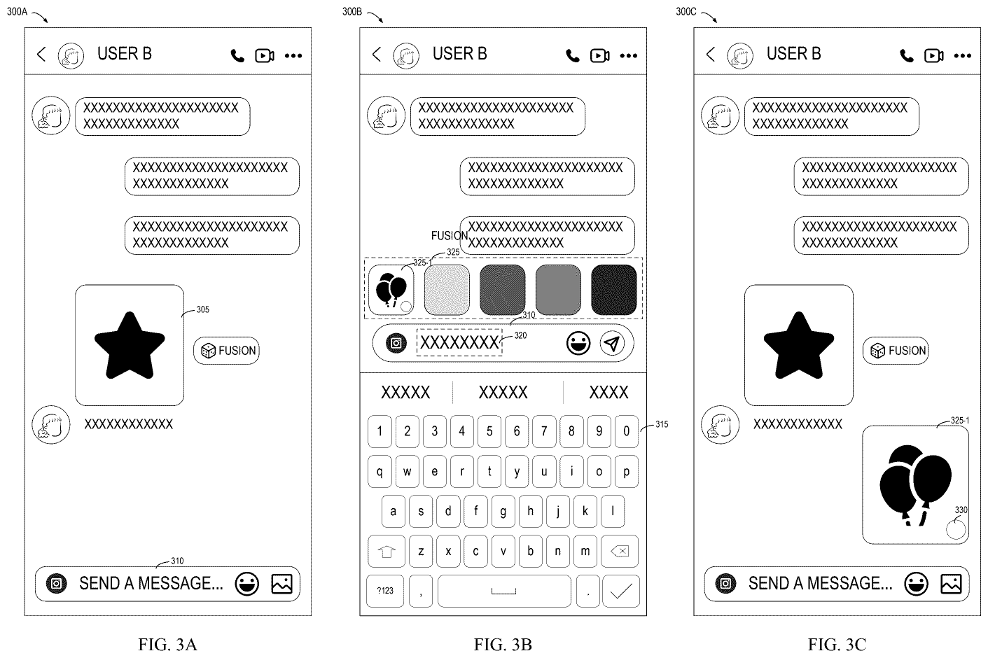

FIG. 4 illustrates a flowchart of an example process 400 of information interaction according to some embodiments of the present disclosure. Process 400 may be implemented at electronic device 110. The process 400 is described below with reference to FIG. 1.

As shown, at block 410, the electronic device 110 presents an interaction portal associated with a first interaction resource sent by a target user, and the first interaction resource is generated based on a first prompt.

At block 420, the electronic device 110 presents an interaction interface in response to receiving a selection of the interaction portal.

At block 430, the electronic device 110 determines, via the interaction interface, a second prompt for generating an interaction resource.

In block 440, the electronic device 110 presents, in the interaction interface, a second interaction resource generated at least based on the second prompt.

At block 450, the electronic device 110 sends the generated second interaction resource to the target user.

In some embodiments, determining, via the interaction interface, a second prompt for generating an interaction resource includes: presenting a first editing control in the interaction interface; and in response to a trigger on the first editing control, providing the second prompt generated based on the first prompt.

In some embodiments, the second prompt is generated through: indicating a first model to generate the second prompt by replacing partial content of the first prompt.

In some embodiments, determining, via the interaction interface, a second prompt for generating an interaction resource includes: presenting a second editing control in the interaction interface; and in response to a trigger on the second editing control, obtaining the second prompt determined through editing the first prompt.

In some embodiments, the second interaction resource is generated through: providing the second prompt and reference information to a second model; and obtaining the second interaction resource generated by the second model.

In some embodiments, the reference information indicates at least one of: description information associated with the first interaction resource; and avatar data of a virtual object associated with a current user.

In some embodiments, the process 400 further includes: presenting the first prompt for generating the first interaction resource and the first interaction resource in a target interface.

In some embodiments, the target interface includes: a session interface with the target user, the first interaction resource being presented as at least part of a session message; or a comment interface associated with the target user, the first interaction resource being presented as at least part of a comment content.

In some embodiments, the process 400 further includes: presenting the second prompt in association with the sent second interaction resource in the target interface.

In some embodiments, sending the generated second interaction resource to the target user includes: presenting, in the interaction interface, a sending control associated with the second interaction resource; and in response to a trigger on the sending control, sending the generated second interaction resource to the target user.

In some embodiments, the process 400 further includes: obtaining a target content input by a current user via an input control; presenting a third interaction resource associated with the target content, wherein the third interaction resource is generated based on the target content, or the third interaction resource is an interaction resource matching the target content in a predetermined resource set, the predetermined resource set comprising the second interaction resource; and in response to a selection of the third interaction resource, inputting the third interaction resource in a page corresponding to the input control.

In some embodiments, the process 400 further includes: determining, from the predetermined resource set, the third interaction resource based on prompts corresponding to the predetermined resource set, wherein a third prompt corresponding to the third interaction resource matches the target content.

In some embodiments, the process 400 further includes: presenting a prompting element associated with the third interaction resource, the prompting element being configured to indicate that the third interaction resource is generated based on a corresponding prompt.

### Example Apparatus and Device

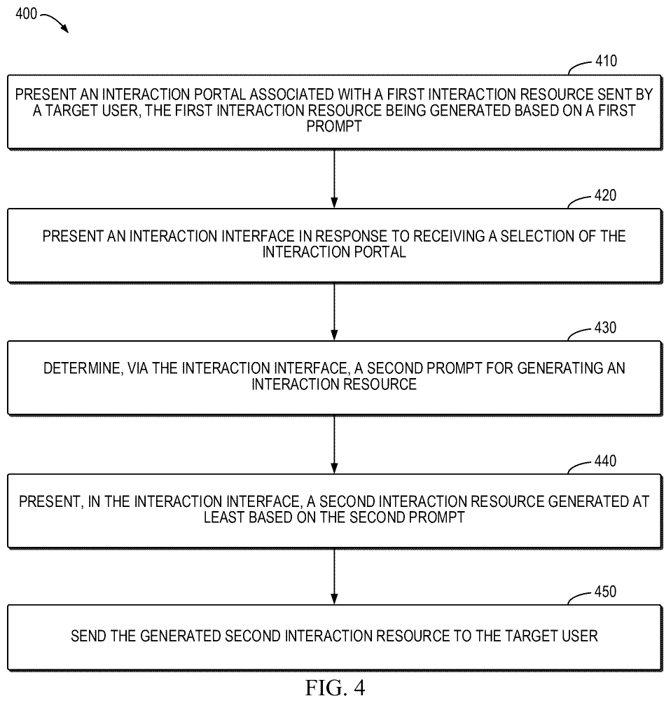

Embodiments of the present disclosure also provide a corresponding apparatus for implementing the above method or process. FIG. 5 shows a schematic structural block diagram of an example apparatus 500 for information interaction according to some embodiments of the present disclosure. The apparatus 500 may be implemented as or included in an electronic device. The various modules/components in the apparatus 500 may be implemented by hardware, software, firmware, or any combination thereof.

As shown in FIG. 5, the apparatus 500 includes a first presenting module 510, configured to present an interaction portal associated with a first interaction resource sent by a target user, the first interaction resource being generated based on a first prompt; an interaction module 520, configured to present an interaction interface in response to receiving a selection of the interaction portal; a determining module 530, configured to determine, via the interaction interface, a second prompt for generating an interaction resource; a second presenting module 540, configured to present, in the interaction interface, a second interaction resource generated at least based on the second prompt; and a sending module 550, configured to send the generated second interaction resource to the target user.

In some embodiments, the determining module 530 is further configured to: present a first editing control in the interaction interface; and in response to a trigger on the first editing control, provide the second prompt generated based on the first prompt.

In some embodiments, the second prompt is generated through: indicating a first model to generate the second prompt by replacing partial content of the first prompt.

In some embodiments, the determining module 530 is further configured to: present a second editing control in the interaction interface; and in response to a trigger on the second editing control, obtain the second prompt determined through editing the first prompt.

In some embodiments, the second interaction resource is generated through: providing the second prompt and reference information to a second model; and obtaining the second interaction resource generated by the second model.

In some embodiments, the reference information indicates at least one of: description information associated with the first interaction resource; and avatar data of a virtual object associated with a current user.

In some embodiments, the apparatus 500 further includes a third presenting module configured to present the first prompt for generating the first interaction resource and the first interaction resource in a target interface.

In some embodiments, the target interface includes: a session interface associated with the target user, the first interaction resource being presented as at least part of a session message; or a comment interface associated with the target user, the first interaction resource being presented as at least part of a comment content.

In some embodiments, the apparatus 500 further includes an association module configured to present the second prompt in association with the sent second interaction resource in the target interface.

In some embodiments, the sending module 550 is further configured to: present, in the interaction interface, a sending control associated with the second interaction resource; and in response to a trigger on the sending control, send the generated second interaction resource to the target user.

In some embodiments, the apparatus 500 further includes a first processing module configured to: obtain a target content input by a current user via an input control; present a third interaction resource associated with the target content, wherein the third interaction resource is generated based on the target content, or the third interaction resource is an interaction resource matching the target content in a predetermined resource set, the predetermined resource set comprising the second interaction resource; and in response to a selection of the third interaction resource, input the third interaction resource in a page corresponding to the input control.

In some embodiments, the apparatus 500 further includes a second processing module configured to: determine, from the predetermined resource set, the third interaction resource based on prompts corresponding to the predetermined resource set, where a third prompt corresponding to the third interaction resource matches the target content.

In some embodiments, the apparatus 500 further includes a prompt module configured to: present a prompting element associated with the third interaction resource, the prompting element being configured to indicate that the third interaction resource is generated based on a corresponding prompt.

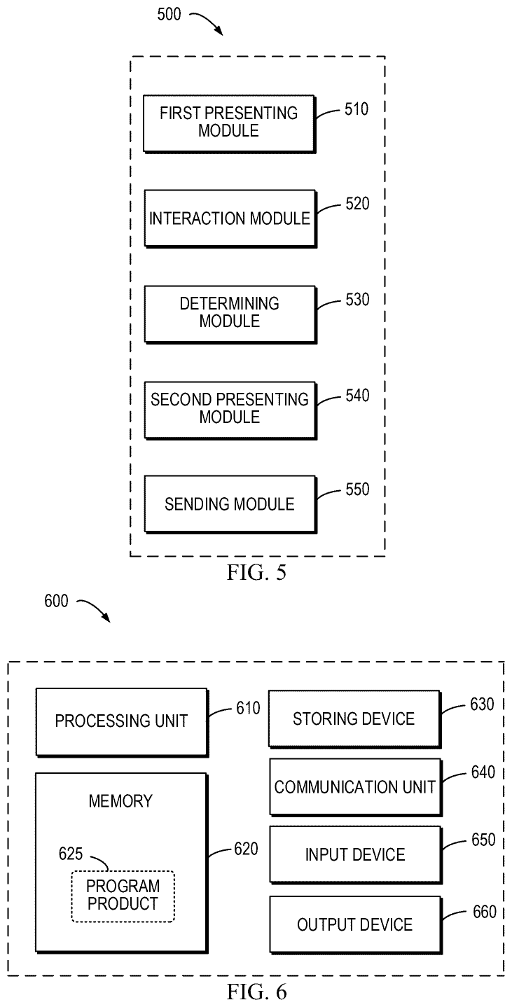

FIG. 6 illustrates a block diagram of an electronic device 600 in which one or more embodiments of the present disclosure may be implemented. It should be understood that the electronic device 600 illustrated in FIG. 6 is merely exemplary and should not constitute any limitation on the functionality and scope of the embodiments described herein. The electronic device 600 shown in FIG. 6 may be used in an electronic device.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor systems, multiple processing units execute computer-executable instructions in parallel to improve parallel processing capabilities of electronic device 600.

Electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data and may be accessed within electronic device 600.

The electronic device 600 may further include additional removable/non-removable, volatile/non-volatile storage media. Although not shown in FIG. 6, a magnetic disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a network environment using logical connections with one or more other servers, network personal computers (PCs), or another network node.

The input device 650 may be one or more input devices such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the present disclosure, there is provided a computer-readable storage medium having computer-executable instructions stored thereon, where the computer-executable instructions, when executed by a processor, implement the method described above. According to example implementations of the present disclosure, a computer program product is further provided, the computer program product being tangibly stored on a non-transitory computer-readable medium and including computer-executable instructions, where the computer-executable instructions, when executed by a processor, implement the method described above.

Aspects of the present disclosure are described herein with reference to flowcharts and/or block diagrams of methods, apparatuses, devices, and computer program products implemented according to the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general-purpose computer, special purpose computer, or other programmable data processing apparatus to produce a machine, such that the instructions, when executed by a processing unit of a computer or other programmable data processing apparatus, produce apparatus for implementing the functions/acts specified in the flowchart and/or block diagram. These computer-readable program instructions may also be stored in a computer-readable storage medium that cause the computer, programmable data processing apparatus, and/or other devices to run in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram(s).

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of instructions that include one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method for information interaction, comprising:
presenting an interaction portal associated with a first interaction resource sent by a target user, the first interaction resource being generated based on a first prompt;
presenting an interaction interface in response to receiving a selection of the interaction portal;
determining, via the interaction interface, a second prompt for generating an interaction resource;
presenting, in the interaction interface, a second interaction resource generated at least based on the second prompt; and
sending the generated second interaction resource to the target user.

2. The method of claim 1, wherein determining, via the interaction interface, a second prompt for generating an interaction resource comprises:
presenting a first editing control in the interaction interface; and
in response to a trigger on the first editing control, providing the second prompt generated based on the first prompt.

3. The method of claim 2, wherein the second prompt is generated through:
indicating a first model to generate the second prompt by replacing partial content of the first prompt.

4. The method of claim 1, wherein determining, via the interaction interface, a second prompt for generating an interaction resource comprises:
presenting a second editing control in the interaction interface; and
in response to a trigger on the second editing control, obtaining the second prompt determined through editing the first prompt.

5. The method of claim 1, wherein the second interaction resource is generated through:
providing the second prompt and reference information to a second model; and
obtaining the second interaction resource generated by the second model.

6. The method of claim 5, wherein the reference information indicates at least one of:
description information associated with the first interaction resource;
avatar data of a virtual object associated with a current user.

7. The method of claim 1, further comprising:
presenting the first prompt for generating the first interaction resource and the first interaction resource in a target interface.

8. The method of claim 7, wherein the target interface comprises:
a session interface associated with the target user, the first interaction resource being presented as at least part of a session message; or
a comment interface associated with the target user, the first interaction resource being presented as at least part of a comment content.

9. The method of claim 7, further comprising:
presenting the second prompt in association with the sent second interaction resource in the target interface.

10. The method of claim 1, wherein sending the generated second interaction resource to the target user comprises:
presenting, in the interaction interface, a sending control associated with the second interaction resource; and
in response to a trigger on the sending control, sending the generated second interaction resource to the target user.

11. The method of claim 1, further comprising:
obtaining a target content input by a current user via an input control;
presenting a third interaction resource associated with the target content, wherein the third interaction resource is generated based on the target content, or the third interaction resource is an interaction resource matching the target content in a predetermined resource set, the predetermined resource set comprising the second interaction resource; and
in response to a selection of the third interaction resource, inputting the third interaction resource in a page corresponding to the input control.

12. The method of claim 11, further comprising:
determining, from the predetermined resource set, the third interaction resource based on prompts corresponding to the predetermined resource set, wherein a third prompt corresponding to the third interaction resource matches the target content.

13. The method of claim 11, further comprising:
presenting a prompting element associated with the third interaction resource, the prompting element being configured to indicate that the third interaction resource is generated based on a corresponding prompt.

14. An electronic device, comprising:
at least one processing unit; and
at least one memory coupled to the at least one processing unit and storing instructions for execution by the at least one processing unit, the instructions, when executed by the at least one processing unit, cause the electronic device to perform acts comprising:
presenting an interaction portal associated with a first interaction resource sent by a target user, the first interaction resource being generated based on a first prompt;
presenting an interaction interface in response to receiving a selection of the interaction portal;
determining, via the interaction interface, a second prompt for generating an interaction resource;
presenting, in the interaction interface, a second interaction resource generated at least based on the second prompt; and
sending the generated second interaction resource to the target user.

15. The electronic device of claim 14, wherein determining, via the interaction interface, a second prompt for generating an interaction resource comprises:
presenting a first editing control in the interaction interface; and
in response to a trigger on the first editing control, providing the second prompt generated based on the first prompt.

16. The electronic device of claim 15, wherein the second prompt is generated through:
indicating a first model to generate the second prompt by replacing partial content of the first prompt.

17. The electronic device of claim 14, wherein determining, via the interaction interface, a second prompt for generating an interaction resource comprises:
presenting a second editing control in the interaction interface; and
in response to a trigger on the second editing control, obtaining the second prompt determined through editing the first prompt.

18. The electronic device of claim 14, wherein the second interaction resource is generated through:
providing the second prompt and reference information to a second model; and
obtaining the second interaction resource generated by the second model.

19. The electronic device of claim 18, wherein the reference information indicates at least one of:
description information associated with the first interaction resource;
avatar data of a virtual object associated with a current user.

20. A non-transitory computer-readable storage medium having a computer program stored thereon, the computer program, when executed by a processor, implements acts comprising:
presenting an interaction portal associated with a first interaction resource sent by a target user, the first interaction resource being generated based on a first prompt;
presenting an interaction interface in response to receiving a selection of the interaction portal;
determining, via the interaction interface, a second prompt for generating an interaction resource;
presenting, in the interaction interface, a second interaction resource generated at least based on the second prompt; and
sending the generated second interaction resource to the target user.
